(19) United States
(12) Patent Application Publication
(10) Pub. No.: US 2016/0090955 A1
(43) Pub. Date: Mar. 31, 2016

(54) FUEL SUPPLY APPARATUS FOR INTERNAL COMBUSTION ENGINE

(71) Applicant: Takao YUASA, Toyota-shi, Aichi-ken (JP)

(72) Inventor: Takao YUASA, Okazaki-shi (JP)

(73) Assignee: TOYOTA JIDOSHA KABUSHIKI KAISHA, Toyota-shi, Aichi-ken (JP)

(21) Appl. No.: 14/890,825

(22) PCT Filed: Apr. 30, 2014
(86) PCT No.: PCT/IB2014/000638

§ 371 Date: Nov. 12, 2015

(30) Foreign Application Priority Data
May 13, 2013 (JP) 2013-100978

(51) Int. Cl. F02M 55/04; F02M 69/04

(52) U.S. Cl. CPC F02M 55/04; F02M 69/046

(57) ABSTRACT

A fuel supply apparatus for an internal combustion engine includes a low-pressure fuel injection mechanism, a high-pressure fuel injection mechanism, a low-pressure fuel pump, a high-pressure fuel pump, a first pulsation damping element, and an orifice. The first pulsation damping element is provided in a passage, located on. the high-pressure fuel pump-side, in a “fuel pipe interposed between the high-pressure fuel pump and the low-pressure fuel injection mechanism. The orifice is provided in the passage, located on the low-pressure fuel injection mechanism-side relative to the first pulsation damping element, in the fuel pipe.

### BACKGROUND OF THE INVENTION

1. Field of the Invention

The present invention relates to a fuel supply apparatus for an internal combustion engine, and particularly relates to a fuel supply apparatus for an internal combustion engine, which can perform direct fuel injection into a cylinder of the internal combustion engine and fuel injection into an intake port thereof.

2. Description of Related Art

In an internal combustion engine for driving a vehicle to run, which is capable of performing fuel injection into an intake port (hereinafter, referred to as “port injection”) and direct fuel injection into a cylinder (hereinafter, referred to as “cylinder injection”), a fuel supply apparatus that uses a high-pressure fuel pump to pressurize fuel from a feed pump to a high pressure is provided. As the high-pressure fuel pump, a mechanical pump that reciprocates a plunger is frequently used.

In the fuel supply apparatus for an internal combustion engine as described above, it is known that pulsation dampers that damp pulsation are provided respectively near an inlet of the high-pressure fuel pump and on a low-pressure delivery pipe in an engine that uses the cylinder injection and the port injection in combination, for example (see Japanese Patent Application Publication No. 2008-180169 (JP 2008-180169 A, for example). It is also known that the length of a low-pressure fuel passage from the high-pressure fuel pump to the low-pressure delivery pipe is set such that the pulsation resonance frequency falls outside of the normal engine speed range, and that a shut-off valve or an orifice is provided on the low-pressure fuel passage as means for suppressing pulsation (see Japanese Patent Application Publication No. 2007-16795 (JP 2007-16795 A), for example).

### SUMMARY OF THE INVENTION

The fuel supply apparatus for an internal combustion engine as described above can suppress pulsation of a pressure of fuel (hereinafter, also referred to as “fuel pressure”), which is caused by an operation of a low-pressure fuel injection valve, and also can reduce pulsation propagated from the high-pressure fuel pump toward the low-pressure delivery pipe. Nowadays, there has been an increased demand for further reducing pulsation with a reduction in idling speed.

In a case where an engine includes a plurality of banks (cylinder banks) like a V-type engine, pulsation resonance may occur in the low-pressure delivery pipe of the bank. It is difficult to control the pulsation resonance frequency by changing the length of a fuel pipe from the high-pressure fuel pump to a low-pressure fuel injection mechanism. Thus, the fuel supply apparatus cannot meet the demand for further reducing pulsation with a reduction in idling speed.

Further, in a case where a so-called fuel-cut process is performed at the time of deceleration at a high engine speed, for example, at the time of downhill driving, the frequency of fuel-pressure pulsation in a low-pressure-side fuel passage, which is caused by an operation of the high-pressure fuel pump, becomes very high. There is a possibility that the pulsation described above may become too strong to be sufficiently absorbed by the pulsation damper. In that case, the fuel injection amount, required at the time of restarting fuel injection after the fuel-cut state (hereinafter, also referred to as “return time”), cannot be ensured, and thus there may be a possibility of deterioration of vehicle drivability.

Therefore, the present invention provides a fuel supply apparatus for an internal combustion engine, which can effectively suppress fuel-pressure pulsation in a low-pressure-side fuel passage at the idling time or at the return time from a fuel-cut state.

According to a first aspect of the present invention, the fuel supply apparatus for an internal combustion engine includes a low-pressure fuel injection mechanism, a high-pressure fuel injection mechanism, a low-pressure fuel pump, a high-pressure fuel pump, a first pulsation damping element, and an orifice. The low-pressure fuel pump feeds fuel to the internal combustion engine. The high-pressure fuel pump pressurizes fuel fed from the low-pressure fuel pump and feeds the pressurized fuel to the high-pressure fuel injection mechanism. The high-pressure fuel pump is mechanically driven by the internal combustion engine. The first pulsation damping element is configured to reduce at least fuel-pressure pulsation caused by an operation of the high-pressure fuel pump. The first pulsation damping element is provided in a passage that located on the high-pressure fuel pump-side in a fuel pipe interposed between the high-pressure fuel pump and the low-pressure fuel injection mechanism. The orifice partially reduces a cross-sectional area of a passage, located on the low-pressure fuel injection mechanism-side relative to the first pulsation damping element, in the fuel pipe. The orifice is provided in the passage, located on the low-pressure fuel injection mechanism-side relative to the first pulsation damping element, in the fuel pipe.

With this configuration, the pulsation damping element effectively damps at least fuel-pressure pulsation, caused by an operation of the high-pressure fuel pump, in the passage, located on the high-pressure fuel pump-side, in the fuel pipe at an initial stage at which the fuel pressure varies greatly. Further, the orifice reduces the fuel-pressure pulsation having passed through the pulsation damping element. Therefore, fuel-pressure pulsation, propagated from the high-pressure fuel pump to the low-pressure fuel injection mechanism, is effectively reduced over a wide pulsation frequency range through cooperation of the pulsation damping element with the orifice. Thus, it is possible to effectively suppress the fuel-pressure pulsation in a low-pressure-side fuel passage even at the idling time or at the return time from the fuel-cut state. Because the length of a low-pressure fuel passage needs not to be limited, it is still possible even for a V-type internal combustion engine to effectively reduce the fuel-pressure pulsation in the low-pressure-side fuel passage.

Further, according to the first aspect of the present invention, the fuel pipe, interposed between the first pulsation damping element and the orifice, may branch off into the passage, located on the high-pressure fuel pump-side, and into a passage extending from the low-pressure fuel pump to the low-pressure fuel injection mechanism.

With this configuration, a fuel supply amount from the low-pressure fuel pump to the passage, located on the high-pressure fuel pump-side, can be ensured, and also propagation of fuel-pressure pulsation from the passage, located on the high-pressure fuel pump-side, can be effectively suppressed.

Further, according to the first aspect of the present invention, the orifice may be provided at a position on the fuel pipe, which corresponds to a pressure node when the fuel-pressure pulsation becomes strong on the fuel pipe.

With this configuration, the orifice is arranged in the vicinity of the pressure node when the fuel-pressure pulsation becomes strong on the low-pressure fuel passage, that is, a flow velocity antinode on the low-pressure fuel passage, and thus a sufficient effect of reducing the fuel-pressure pulsation is provided by the orifice.

Further, according to the first aspect of the present invention, the orifice may be provided at a position of the fuel pipe, which corresponds to a vicinity of the center of a passage length of the fuel pipe from the high-pressure fuel pump to the low-pressure fuel injection mechanism.

With this configuration, the orifice is arranged in the vicinity of the pressure node, that is, the flow velocity antinode, and thus a sufficient effect of reducing the fuel-pressure pulsation is provided.

Further, according to the first aspect of the present invention, the first pulsation damping element may reduce the fuel-pressure pulsation, caused by an operation of the high-pressure fuel pump, within a first pulsation frequency range, and the orifice may reduce the fuel-pressure pulsation, having passed through the first pulsation damping element, within a second pulsation frequency range. The second pulsation frequency range is at least a pulsation frequency range that has a higher center frequency and is narrower than the first pulsation frequency range.

With this configuration, at the idling time at a low idling speed, for example, fuel-pressure pulsation, caused by an operation of the high-pressure fuel pump, is effectively damped by the pulsation damping element. Thus, even when the pulsation damping effect of the pulsation damping element is insufficient, fuel-pressure pulsation at a high pulsation frequency is effectively suppressed by the orifice at the return time from the fuel-cut state at a high engine speed.

According to the aspect of the present invention, the low-pressure fuel injection mechanism may include a plurality of low-pressure-side fuel distribution pipes that are arranged in parallel, and in the fuel pipe, a passage located on the low-pressure fuel injection mechanism-side relative to a position where the orifice is provided may branch off into a plurality of passages that correspond to the plurality of low-pressure-side fuel distribution pipes. And a second pulsation damping element may be provided on a communication passage between the plurality of low-pressure-side fuel distribution pipes, which includes the plurality of passages. The second pulsation damping element is common to the plurality of low-pressure-side distribution pipes. And the second pulsation damping element reduces fuel-pressure pulsation in the plurality of low-pressure-side fuel distribution pipes, which is caused by an operation of the low-pressure fuel injection mechanism.

With this configuration, even when the low-pressure fuel injection mechanism includes the plurality of low-pressure-side fuel distribution pipes that are arranged in parallel, it is still possible to effectively and inexpensively damp fuel-pressure pulsation in the plurality of low-pressure-side fuel distribution pipes by the pulsation damping element that is common to the plurality of low-pressure-side fuel distribution pipes. This common pulsation damping element can also be utilized for reducing pulsation caused by an operation of the high-pressure fuel pump.

Further, according to the aspect of the present invention, the second pulsation damping element may be provided at a position where the passage, located on the low-pressure fuel injection mechanism-side relative to the position where the orifice is provided, branches off into the plurality of passages.

With this configuration, it is possible to further effectively damp fuel-pressure pulsation in the plurality of low-pressure-side fuel distribution pipes by the second pulsation damping element.

Further, according to the aspect of the present invention, the first pulsation damping element and the second pulsation damping element may be pulsation dampers.

According to the present invention, fuel-pressure pulsation in the low-pressure-side fuel passage, which is caused by an operation of the high-pressure fuel pump, is damped by the pulsation damping element in the vicinity of the high-pressure fuel pump, and also the fuel-pressure pulsation, having passed through the pulsation damping element, is reduced by the orifice. Thus, fuel-pressure pulsation, propagated from the high-pressure fuel pump to the low-pressure fuel injection mechanism, can be, effectively reduced over a wide pulsation frequency range by the pulsation damping element and the orifice. As a result, the fuel supply apparatus for an internal combustion engine can be provided, which can effectively suppress fuel-pressure pulsation in the low-pressure-side fuel passage at the idling time or at the return time from the fuel-cut state.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a schematic configuration diagram of a fuel supply apparatus for an internal combustion engine according to a first embodiment of the present invention;

FIG. 2 is a graph illustrating a comparison between the operation of the configuration of the fuel supply apparatus for an internal combustion engine according to the first embodiment of the present invention and the operations of comparative examples 1, 2, and 3, in which the vertical axis represents half amplitude of fuel-pressure pulsation in a low-pressure-side fuel passage, and the horizontal axis represents engine speed per minute; and

FIG. 3 is a schematic configuration diagram of a fuel supply apparatus for an internal combustion engine according to a second embodiment of the present invention.

### DETAILED DESCRIPTION OF EMBODIMENTS

A preferred embodiment of the present invention is described below with reference to the drawings.

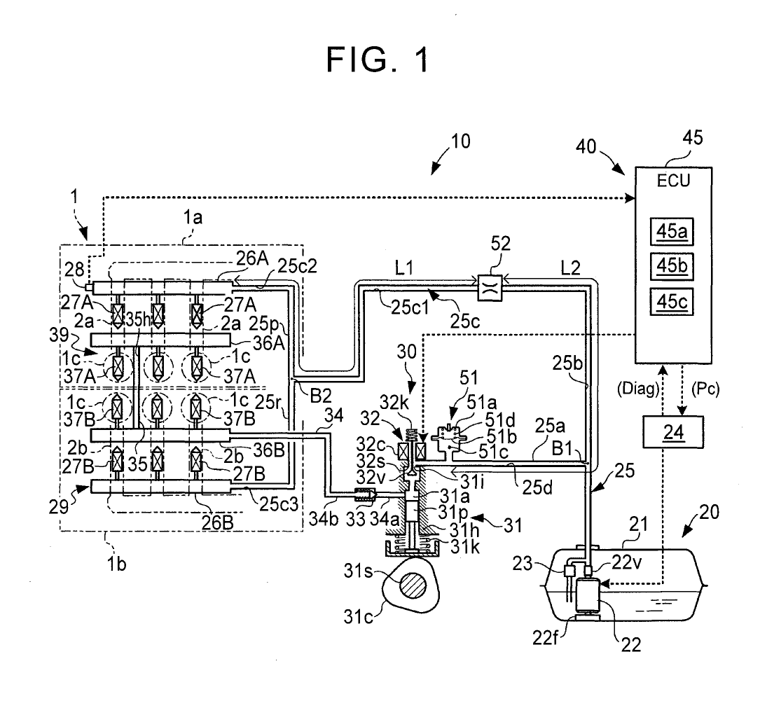

FIG. 1 shows a fuel supply apparatus for an internal combustion engine according to a first embodiment of the present invention.

An engine 1 according to the present embodiment shown in FIG. 1 is configured as a V-type six-cylinder engine (a multi-cylinder internal combustion engine) that is mounted on an automobile (a vehicle). The engine 1 includes a first bank 1a and a second bank 1b, each of which includes three cylinders 1c. In each of the cylinders 1c, a piston is accommodated, a combustion chamber is defined, and an intake valve and an exhaust valve are provided so as to be opened and closed at a predetermined timing. The piston, the combustion chamber, the intake valve, and the exhaust valve are not shown in FIG. 1. In the engine 1, an ignition device, including an ignition plug that is exposed to the interior of the combustion chamber, and an ignition coil that is used to cause the ignition plug to be ignited, is installed, for example. Also, a fuel supply apparatus 10 according to the present embodiment is installed in the engine 1.

The fuel supply apparatus 10 installed in the engine 1 includes a first fuel supply mechanism 20, a second fuel supply mechanism 30, and a fuel-pressure variable mechanism 40. The first fuel supply mechanism 20 is a fuel supply mechanism that feeds fuel (for example, gasoline) to be consumed by the engine 1 at a first pressure level that allows port injection. The second fuel supply mechanism 30 is a fuel supply mechanism that pressurizes the fuel fed at the first pressure level to a high pressure at a second pressure level that allows cylinder injection, and then feeds the pressurized fuel. The fuel-pressure variable mechanism 40 varies and controls the pressure of fuel fed from the first fuel supply mechanism 20 according to the operating conditions of the engine 1.

The first fuel supply mechanism 20 is configured by including a fuel tank 21, an electric feed pump 22 (a low-pressure fuel pump), a relief valve 23, a pump drive circuit 24, a first fuel pipe 25, low-pressure-side delivery pipes 26A and 26B, first injectors 27A and 27B (a plurality of low-pressure fuel injection valves that serve as port-injection valves), and a low-pressure fuel-pressure sensor 28 (a low-pressure-side fuel-pressure sensor).

The fuel tank 21 is a tank configured to have a storing capacity that allows a predetermined amount of fuel to be stored, which is to be consumed by the engine 1, and configured to be capable of feeding fuel. The fuel tank 21 is supported by a body of the automobile.

The feed pump 22 is a variable discharge-capacity (a discharge pressure and a discharge amount) low-pressure fuel pump that draws fuel from the fuel tank 21 and discharges the fuel at the first pressure level. The feed pump 22 is configured by a circumferential flow pump, for example. The feed pump 22 includes a pump operating impeller, and a built-in motor that drives the pump operating portion. The feed pump 22 is configured by including a suction filter 22f, a fuel filter that removes foreign matter from the fuel to be discharged on the outlet side of the feed pump 22, and a discharge check valve 22v. The suction filter 22f is a filter that blocks suction of foreign matter on the inlet side of the feed pump 22. The discharge check valve 22v is a valve that blocks fuel, discharged from the feed pump 22, from flowing backward. The impeller, the built-in motor, and the fuel filter are not shown in FIG. 1.

When the pressure of fuel discharged from the feed pump 22 into the first fuel pipe 25 reaches a set relief pressure that is set in advance, the relief valve 23 is opened. The relief valve 23 is opened, thereby adjusting the pressure of fuel, to be supplied into the first fuel pipe 25, to the set relief pressure or lower.

The pump drive circuit 24 is a circuit that drives the feed pump 22. The pump drive circuit 24 can change the discharge capacity of the feed pump 22 according to a fuel-pressure control signal from an electronic control unit (ECU) 45 described later. The pump drive circuit 24 is a publicly-known circuit.

The first fuel pipe 25 is a low-pressure fuel pipe that branches off at its downstream end into a plurality of branched pipe portions 25p and 25r. The first fuel pipe 25 is configured to supply fuel, which has been discharged from the feed pump 22 and adjusted to the set relief pressure or lower, to the low-pressure-side delivery pipes 26A and 26B that are arranged in parallel.

Each of the low-pressure-side delivery pipes 26A and 26B stores and accumulates therein fuel pressurized to a fuel pressure for port injection. The low-pressure-side delivery pipes 26A and 26B are a plurality of low-pressure-side fuel distribution pipes that are arranged in parallel. First injectors for three port injection 27A on the first bank 1a-side are connected to the low-pressure-side delivery pipe 26A. First injectors for three port injection 27B on the second bank 1b-side are connected to the low-pressure-side delivery pipe 26B. A low-pressure fuel injection mechanism 29 is configured by the low-pressure-side delivery pipes 26A and 26B and the first injectors 27A and 27B.

The low-pressure-side delivery pipes 26A and 26B are connected respectively to the branched pipe portions 25p and 25r of the first fuel pipe 25 so as to communicate with each other.

Fuel, pressurized by the feed pump 22, is introduced through the first fuel pipe 25 into the low-pressure-side delivery pipes 26A and 26B. The low-pressure-side delivery pipes 26A and 26B are metallic delivery pipes that store and accumulate therein introduced fuel. The low-pressure-side delivery pipes 26A and 26B are configured to provide a so-called wall damping function of absorbing fuel-pressure pulsation by being bent according to the pressure of fuel (see Japanese Patent Application Publication No. 2012-002171 (JP 2012-002171 A), for example). That is, the low-pressure-side delivery pipes 26A and 26B have the rate of change in volume (mL/MPa) that is sufficiently higher than that of the first fuel pipe 25, so as to provide the damper function of damping pulsation. The low-pressure-side delivery pipes 26A and 26B are not shown in detail in FIG. 1.

Each of the first injectors for the port injection 27A and 27B is driven and opened according to an injection command signal from the ECU 45. Upon energization of the first injectors for the port-injection 27A and 27B to be driven and opened, the first injectors 27A and 27B inject fuel from injection-hole portions that are exposed to the interior of respective intake passages 2a and 2b of the engine 1. When any of the first injectors 27A and 27B operates to be opened, pressurized fuel within the low-pressure-side delivery pipe 26A or 26B is injected from the injection-hole portion of the first injector 27A or 27B correspondingly into the intake passage 2a or 2b. An injector driver circuit is not shown in FIG. 1.

The low-pressure fuel-pressure sensor 28 detects the pressure of fuel within the low-pressure-side delivery pipe 26A or 26B to detect the pressure of fuel supplied from the feed pump 22 to the first injectors for the port-injection 27A and 27B. The low-pressure fuel-pressure sensor 28 detects the pressure of fuel on the most downstream side of a fuel supply path. The low-pressure fuel-pressure sensor 28 is a publicly known sensor.

The second fuel supply mechanism 30 is configured by including a high-pressure fuel pump 31 (a fuel pressurizing pump), a suction control valve 32, a discharge check valve 33, a second fuel pipe 34, a third fuel pipe 35, high-pressure-side delivery pipes 36A and 36B, and second injectors 37A and 37B (high-pressure fuel injection valves that serve as cylinder-injection valves).

The high-pressure fuel pump 31 is a publicly-known plunger-type fuel pressurizing pump that sucks in fuel pressurized by the feed pump 22, pressurizes the fuel to a high pressure, and discharges the pressurized fuel. The high-pressure fuel pump 31 includes a pressurizing chamber 31a into which fuel, which has been pressurized by the feed pump 22 and adjusted to a set pressure by the relief valve 23, is introduced through a branched passage portion 25a of the first fuel pipe 25.

The high-pressure fuel pump 31 pressurizes fuel within the pressurizing chamber 31a to the second pressure level that is higher than the first pressure level, and discharges the pressurized fuel. Thus, the high-pressure fuel pump 31 can supply high-pressure fuel into the second fuel pipe 34 on the second injectors for the cylinder-injection 37A and 37B-side. The high-pressure fuel pump 31 is attached to one of banks of the engine 1, for example, to the second bank 1b. The high-pressure fuel pump 31 is driven by rotational power from the engine 1 (rotational power of a camshaft 31s described later).

Specifically, the high-pressure fuel pump 31 includes a pump housing 31h, a plunger 31p, a spring 31k, and a drive cam 31c. The pump housing 31h is integrally attached to the second bank 1b. The plunger 31p is provided to slidably reciprocate within the pump housing 31h. The spring 31k urges the plunger 31p. The plunger 31p is urged by the spring 31k toward one side of the plunger 31p in its axial direction, for example, toward the side on which the plunger 31p approaches the camshaft 31s. The drive cam 31c is a cam fixed to a camshaft that is a part of a valve-driving mechanism of the engine 1. The camshaft is rotated by rotational power from a crankshaft at a rotational speed that is half of the rotational speed of the crankshaft. The rotations of the camshaft drive the plunger 31p to be raised and lowered in the vertical direction in FIG. 1 through the drive cam 31c.

The volume of the pressurizing chamber 31a, defined by the plunger 31p within the pump housing 31h, is changed by reciprocation of the plunger 31p. With this configuration, the high-pressure fuel pump 31 can perform suction of fuel from the feed pump 22, and can perform fuel pressurization and discharge work.

The suction control valve 32 has a check-valve function of blocking high-pressure fuel within the pressurizing chamber 31a from flowing backward on an inlet 31i-side of the high-pressure fuel pump 31. When the suction control valve 32 is opened according to an input signal, fuel within the pressurizing chamber 31a can flow out to the low-pressure side depending on the movement of the plunger 31p.

The suction control valve 32 includes a poppet-shaped valve body 32v, a valve seat 32s, a valve spring 32k, and an electromagnetically-driven coil 32c. The valve seat 32s is provided so as to form the inlet 31i on the pump housing 31h. The valve spring 32k normally urges the valve body 32v toward one side of the valve body 32v in its axial direction, for example, toward the valve-opening direction. The electromagnetically-driven coil 32c can urge the valve body 32v toward the other side in its axial direction, for example, toward the valve-closing direction. That is, the suction control valve 32 is a normally-open type valve that is in a normally-open state at the time of non-energization (non-excitation), for example. The suction control valve 32 is driven and controlled by the ECU 45 through the injector driver circuit. The electromagnetically-driven coil 32c of the suction control valve 32 is connected to the injector driver circuit.

The discharge check valve 33 is a spring check valve that is provided at the upstream portion of the second fuel pipe 34 between the high-pressure fuel pump 31 and the second injectors for the cylinder-injection 37A and 37B. The discharge check valve 33 is opened when a pressure difference between the front and rear of the discharge check valve 33 becomes equal to or larger than a predetermined pressure-difference value (for example, several tens of kPa) in order to allow a fuel supply to the second injectors for the cylinder-injection 37A and 37B. The pressure difference between the front and rear of the discharge check valve 33 is a difference between the fuel pressure within a passage portion 34a, located on the high-pressure fuel pump 31-side relative to the discharge check valve 33, in the second fuel pipe 34, and the fuel pressure within a passage portion 34b, located on the downstream side of the second fuel pipe 34 relative to the discharge check valve 33. When the fuel pressure within the passage portion 34a on the high-pressure fuel pump 31-side becomes equal to or lower than the fuel pressure within the passage portion 34b on the downstream side, the discharge check valve 33 is closed. Closing the discharge check valve 33 can block high-pressure fuel from flowing backward to the high-pressure fuel pump 31-side.

The second fuel pipe 34 is a high-pressure fuel pipe that extends from the high-pressure fuel pump 31 to either of the high-pressure-side delivery pipes 36A or 36B. The third fuel pipe 35 is a connecting pipe that connects the high-pressure-side delivery pipes 36A and 36B so as to communicate with each other.

Fuel, pressurized to the second pressure level, is introduced through the second fuel pipe 34 into the high-pressure-side delivery pipes 36A and 36B. The high-pressure-side delivery pipes 36A and 36B are high-rigidity fuel distribution pipes that accumulate therein the introduced fuel.

Second injectors for three (plural) cylinder-injection 37A (high-pressure fuel injection valves that serve as cylinder-injection valves), each of which injects fuel into the three cylinders 1c (for example, a first cylinder, a third cylinder, and a fifth cylinder) of the first bank 1a, are connected to the high-pressure-side, delivery pipe 36A. Also, three second injectors for cylinder-injection 37B (high-pressure fuel injection valves that serve as cylinder-injection valves), each of which injects fuel into each of the three cylinders 1c (for example, a second cylinder, a fourth cylinder, and a sixth cylinder) of the second bank 1b, are connected to the high-pressure-side delivery pipe 36B. A high-pressure fuel injection mechanism 39 is composed of the high-pressure-side delivery pipes 36A and 36B and the second injectors 37A and 37B.

Each of the second injectors 37A and 37B is driven and opened according to an injection command signal output from the ECU 45. The injection command signal output from the ECU 45 is transmitted to the second injectors 37A and 37B through the injector driver circuit. The injection command signal is not shown in detail in FIG. 1. When the second injectors 37A and 37B are driven and opened, the second injectors 37A and 37B inject fuel respectively into the cylinders 1c from injection-holes exposed to the interior of the combustion chambers of the cylinders 1c. The second injectors 37A and 37B are connected to and supported by the high-pressure-side delivery pipes 36A and 36B at almost equal pitch, corresponding to the cylinders 1c. When any of the second injectors 37A and 37B operates to be opened, high-pressure fuel, pressurized within the high-pressure-side delivery pipe 36A or 36B, is injected from the injection-hole of the second injector, 37A or 37B into the combustion chamber of a corresponding one of the cylinders 1c.

The first fuel pipe 25 includes the branched pipe portions 25p and 25r on its downstream side, into which a low-pressure fuel passage 25c, interposed between the low-pressure fuel injection mechanism 29 and the second fuel supply mechanism 30, branches off. The low-pressure fuel passage 25c is a branch pipe that branches off from an upstream passage portion 25c1 into a plurality of branched passage portions 25c2 and 25c3. The branched pipe portions 25p and 25r form a communication passage between the low-pressure-side delivery pipes 26A and 26B, which includes the branched passage portions 25c2 and 25c3.

A pulsation damper 51 (a pulsation damping element) is provided on the branch passage portion 25a that is a passage portion, located on the high-pressure fuel pump 31-side, in the first fuel pipe 25 interposed between the high-pressure fuel pump 31 and the low-pressure fuel injection mechanism 29 and including the low-pressure fuel passage 25c. The pulsation damper 51 can reduce at least fuel-pressure pulsation in the low-pressure fuel passage 25c, which is caused by an operation of the high-pressure fuel pump 31.

The pulsation damper 51 has the following configuration, for example. The pulsation damper 51 includes a case 51a that introduces therein fuel, a diaphragm 51b that forms a pulsation damping chamber 51c within the case 51a, and a spring element 51d that urges the diaphragm 51b in the direction opposite to the fuel-pressure receiving direction. The pulsation damper 51 can damp fuel-pressure pulsation, while changing the volume of the pulsation damping chamber 51c according to the fuel pressure that acts on the diaphragm 51b.

The pulsation damper 51 is arranged adjacent to the inlet 31i of the high-pressure fuel pump 31 and on the upstream side of the inlet 31i.

When the suction control valve 32 is opened (when the inlet 31i is opened), the plunger 31p of the high-pressure fuel pump 31 reciprocates. Due to the reciprocation of the plunger 31p, fuel-pressure pulsation is propagated from the high-pressure fuel pump 31-side to the low-pressure fuel passage 25c. The pulsation damper 51 reduces the propagated fuel-pressure pulsation in the low-pressure fuel passage 25c within a first pulsation frequency range that is set in advance. The fuel-pressure pulsation also includes a pulsation component resulting from reflection.

The first pulsation frequency range described herein corresponds to a frequency range within which the frequency of fuel-pressure pulsation, caused by reciprocation of the plunger 31p of the high-pressure fuel pump 31, can be changed in the normal speed range of the engine 1 (according to changes in engine rotational speed during a normal operation). The first pulsation frequency range is set in advance based on the test results and the like.

An orifice 52 is provided on a passage portion 25d, located on the low-pressure fuel injection mechanism 29-side relative to the pulsation damper 51, in the first fuel pipe 25. The orifice 52 has an orifice shape and partially reduces the cross-sectional area of the passage portion 25d. The orifice 52 is not only configured by an orifice plate with a circular orifice hole, but the orifice 52 may also be configured by an orifice plate that narrows the cross section of a part of the passage portion 25d into any cross-sectional shape such as a substantially D-shape, an elliptical shape, and a semicircular shape. The orifice 52 may also include a nozzle portion that forms an orifice hole. The nozzle portion may be any of a nozzle with a curved surface, such as a quadrant nozzle and a contour nozzle, a nozzle with a chambered surface, and a nozzle with a square-edge shape. That is, the shape of the orifice 52 is not particularly limited as long as required orifice characteristics can be obtained from the orifice 52.

The shape of the orifice 52 is set so as to have orifice characteristics that can reduce fuel-pressure pulsation, having been propagated from the high-pressure fuel pump 31-side and passed through the pulsation damper 51, within a second pulsation frequency range. The second pulsation frequency range is a range that has a higher center frequency and is narrower than the first pulsation frequency range, for example.

The second pulsation frequency range described herein corresponds to a range within which the frequency of fuel-pressure pulsation, caused by an operation of the high-pressure fuel pump 31, can be changed when the engine rotational speed falls within the high rotational speed range. The high rotational speed range is a rotational speed range on the higher side than the center rotational speed of the engine rotational speed when the engine operates normally. For example, a specific frequency range, within which fuel-pressure pulsation, caused by an operation of the high-pressure fuel pump 31, is effectively damped or is substantially blocked when the rotational speed of the engine 1 is on the higher side than the fuel-cut rotational speed, corresponds to the second pulsation frequency range.

The fuel-cut rotational speed described herein is an engine rotational speed that defines an engine rotational speed range within which a fuel-cut control can be executed. The fuel-cut control is a control to stop fuel injection for the purposes of improving fuel economy, purifying exhaust gas, and so on at the time of deceleration and the like of a vehicle mounted with the engine 1. The fuel-cut control may also be a control to stop fuel injection at the time of idling stop or at the time of automatically stopping the engine in a hybrid vehicle. For example, at the time of deceleration of a vehicle, when the engine rotational speed is equal to or higher than the fuel-cut rotational speed, the fuel-cut control is executed. Further, when an acceleration operation is performed or when the engine rotational speed is reduced, by the fuel-cut control, to a preset rotational speed for returning from the fuel-cut state, fuel injection is restarted and a normal fuel injection control is restarted (returning from the fuel cut state).

The fuel-cut rotational speed and the rotational speed for returning from the fuel-cut state are calculated and set based on the coolant temperature and the like of the engine 1. Therefore, the second pulsation frequency range described in the present embodiment is a frequency range, within which fuel-pressure pulsation, caused by an operation of the high-pressure fuel pump 31, is effectively damped or is substantially blocked when the rotational speed of the engine 1 is on the higher side than the fuel-cut rotational speed. The fuel-cut rotational speed is set based on the coolant temperature and the like in the normal speed range after warming-up of the engine 1 is completed.

Between the pulsation damper 51 and the orifice 52, a branch point B1 is set, at which the first fuel pipe 25 branches off into the branch passage portion 25a that is a passage portion located on the high-pressure fuel pump 31-side and into a main passage portion 25b extending from the feed pump 22 to the low-pressure fuel injection mechanism 29.

On a fuel passage within the first fuel pipe 25, which is constituted by a part of the main passage portion 25b and by a part of the branch passage portion 25a, the orifice 52 is arranged at a position corresponding to a pressure node when fuel-pressure pulsation becomes strong. That is, the orifice 52 is arranged at a position corresponding to the pressure node when the pulsation resonates or nearly resonates, for example, when the pulsation is increased. The pressure node described herein is a position where, when fuel-pressure pulsation in the fuel passage becomes strong, a fuel-pressure variation component becomes smallest and a flow-velocity component becomes largest in each portion of the fuel passage in its lengthwise direction. The pressure node corresponds to a velocity antinode.

In the present embodiment, the orifice 52 is arranged in the vicinity of the center of the length of the fuel passage, and fuel passage lengths L1 and L2 on both sides of the orifice 52 are substantially equal to each other. In this case, a pressure antinode, when fuel-pressure pulsation in the fuel passage becomes strong, is formed at both end sides of the fuel passage in its lengthwise direction.

A branch point B2, at which the upstream passage portion 25c1 of the fuel passage branches off into the branched passage portions 25c2 and 25c3, is positioned on the low-pressure fuel injection mechanism 29-side relative to the orifice 52. That is, the upstream passage portion 25c1 branches off on the downstream side of the orifice 52 into the branched passage portions 25c2 and 25c3 that correspond to the low-pressure-side delivery pipes 26A and 26B, respectively.

The fuel-pressure variable mechanism 40 is configured by including the pump drive circuit 24, the low-pressure fuel-pressure sensor 28, and the ECU 45.

The fuel-pressure variable mechanism 40 executes an ON/OFF control and a discharge-capability (a discharge pressure or/and a discharge amount) variable control of the feed pump 22 by the ECU 45 through the pump drive circuit 24. In this manner, the fuel-pressure variable mechanism 40 can variably control the pressure of fuel to be supplied from the feed pump 22 (a feed fuel pressure).

The ECU 45 includes a central processing unit (CPU), a read only memory (ROM), a random access memory (RAM), and a backup memory constituted by a nonvolatile memory. Further, the ECU 45 is configured by including an input interface circuit that includes an A/D converter and the like, an output interface circuit that includes a driver and a relay switch, and so on. A hardware configuration of the ECU 45 is not shown in detail in FIG. 1.

A diagnosis output section of the pump drive circuit 24, the low-pressure fuel-pressure sensor 28, and various other sensors are connected to the input interface circuit in the ECU 45. The pump drive circuit 24, the electromagnetically-driven coil 32c of the suction control valve 32, and other devices such as the ignition device, an electronically-controlled throttle motor, and the injector driver circuit are connected to the output interface circuit in the ECU 45. Various other sensors, the ignition device, the electronically-controlled throttle motor, and the injector driver circuit are not shown in FIG. 1.

According to a control program stored in advance in the ROM, the ECU 45 outputs a control signal based on information obtained from various sensors, set-value information stored in the backup memory, a map stored in advance in the ROM, and other information. Further, the ECU 45 outputs a control signal, while communicating with other in-vehicle ECUs. For example, the ECU 45 calculates the fuel injection amount according to the operating conditions of the engine 1, the acceleration operation, and the like, and timely outputs an injection command signal to the first injectors 27A and 27B and the second injectors 37A and 37B, a discharge control signal for driving the suction control valve 32, and other signals.

By at least adjusting the amount of fuel leaking from the pressurizing chamber 31a through the suction control valve 32, the ECU 45 can control the pressure of fuel, to be supplied from the high-pressure fuel pump 31 to the high-pressure-side delivery pipes 36A and 36B, to an optimum fuel pressure according to the operating conditions of the engine 1 and the injection characteristics of the second injectors for the cylinder-injection 37A and 37B. For example, the ECU 45 can variably set the ON time, during which the electromagnetically-driven coil 32c of the suction control valve 32 is in an excited state, and the OFF time, during which the electromagnetically-driven coil 32c is released from the excited state, in a given signal cycle. The ECU 45 changes the ratio of the ON time (the duty ratio) in the signal cycle relative to the OFF time, and thus can control the timing at which the high-pressure fuel pump 31 performs a fuel pressurization and discharge operation, and can control the discharge amount of the high-pressure fuel pump 31.

Furthermore, at the time of engine start, the ECU 45 first causes the first injectors for the port-injection 27A and 27B to perform fuel injection. Thereafter, when the fuel pressure within the high-pressure-side delivery pipes 36A and 36B (hereinafter, also referred to as “high-pressure delivery fuel pressure”) reaches the second pressure level required for the second injectors for the cylinder-injection 37A and 37B to perform fuel injection, the ECU 45 starts outputting the injection command signal to the second injectors for the cylinder-injection 37A and 37B.

For example, while cylinder injection from the second injectors 37A and 37B is principally performed, the ECU 45 also uses port injection in combination with the cylinder injection under specific operating conditions in which the cylinder injection alone is not sufficient to form an air-fuel mixture. Examples of the specific operating conditions include starting-up and warming-up of the engine 1 and low-speed, high-load conditions. The ECU 45 also causes the first injectors 27A and 27B to perform the port injection under high-speed, high-load conditions in which the port injection is effective.

Still furthermore, in order to configure a plurality of functional sections as described below, the ECU 45 has a control program, a map, and the like stored and incorporated in its ROM corresponding to the functional sections.

That is, first the ECU 45 includes a pulsation amplitude detection section 45a that detects the fuel-pressure pulsation amplitude based on the fuel pressure within the low-pressure-side delivery pipe 26A, which is information detected by the low-pressure fuel-pressure sensor 28. The pulsation amplitude detection section 45a detects the fuel-pressure pulsation amplitude that is a difference in feed fuel pressure of fuel, supplied from the feed pump 22, between predetermined detection cycles, or that is a difference between a maximum value and a minimum value of a detected pressure for each predetermined detection period. The ECU 45 also includes an injection amount correction section 45b that corrects the port fuel injection amount according to changes in the port injection amount, which are caused by pulsation with a fuel pressure pulsation amplitude detected by the pulsation amplitude detection section 45a. The injection amount correction section 45b corrects the amount of port injection to be performed immediately after pulsation with the fuel-pressure pulsation amplitude (after a rotation by a predetermined crank angle component) based on the fuel-pressure pulsation amplitude, a pulsation detection delay time, and a predetermined crank angle time after the pulsation detection (for example, 30° CA).

In the present embodiment, at least during an operation of the engine 1, when the second injectors for the cylinder-injection 37A and 37B shift, to a closed state or when the second injectors for the cylinder-injection 37A and 37B and the first injectors for the port-injection 27A and 27B shift to a closed state during an operation of the engine 1, the pulsation amplitude detection section 45a in the ECU 45 detects the fuel-pressure pulsation amplitude within the low-pressure fuel passage 25c from the feed pump 22 to the high-pressure fuel pump 31. A state in which the cylinder-injection second injectors 37A and 37B and the first injectors for the port-injection 27A and 27B are closed during an operation of the engine 1 is the fuel-cut state. The fuel-cut state is a state in which a fuel supply from the second injectors for the cylinder-injection 37A and 37B and a fuel supply from the first injectors for the port-injection 27A and 27B are both stopped under predetermined operating conditions of the engine 1 (for example, at the time of deceleration or downhill driving of a vehicle when the acceleration opening is zero).

The ECU 45 further includes a fuel-pressure control section 45c that changes over and controls the feed fuel pressure based on the operating conditions of the engine 1. Examples of the operating conditions of the engine 1 include the required injection amount and the temperature of fuel fed from the feed pump 22 through the first fuel pipe 25 to the low-pressure-side delivery pipes 26A and 26B and to the high-pressure fuel pump 31-side. The fuel-pressure control section 45c holds the feed fuel pressure to the high-pressure side in the variable control range, up until the discharge flow amount of the high-pressure fuel pump 31 reaches a preset normal flow amount level, or up until the injection amount [mm³/ms] of the second injectors 37A and 37B for the cylinder-injection reaches a state exceeding a given flow amount.

Next, the operation is described.

In the fuel supply apparatus for an internal combustion engine according to the present embodiment configured as described above, the pulsation damper 51 is provided on the branched passage portion 25a, located on the high-pressure fuel pump 31-side, in the first fuel pipe 25 between the high-pressure fuel pump 31 and the low-pressure fuel injection mechanism 29, such that the pulsation damper 51 is positioned adjacent to the inlet 31i of the high-pressure fuel pump 31. Also, the orifice 52 that partially reduces the cross-sectional area of the passage portion 25d is provided on the passage portion 25d located on the low-pressure fuel injection mechanism 29-side relative to the pulsation damper 51. Therefore, in a passage portion, located on the high-pressure fuel pump 31-side, in the first fuel pipe 25, the pulsation damper 51 effectively damps at least fuel-pressure pulsation, caused by an operation of the high-pressure fuel pump 31, at an initial stage at which the pressure varies greatly. Further, the orifice 52 reduces the fuel-pressure pulsation having passed through the pulsation damper 51. As a result, the fuel-pressure pulsation, propagated from the high-pressure fuel pump 31 to the low-pressure fuel injection mechanism 29, is effectively reduced over a wide pulsation frequency range through cooperation of the pulsation damper 51 with the orifice 52. This makes it possible to effectively suppress the fuel-pressure pulsation on the low-pressure side even at the idling time or at the return time from the fuel-cut state, thereby preventing the air-fuel ratio from being varied by instability of the port injection amount. Moreover, it is still possible even for the engine 1 of the V type to effectively reduce fuel-pressure pulsation on the low-pressure side.

In the present embodiment, between the pulsation damper 51 and the orifice 52, the branch point B1 is set, at which the first fuel pipe 25 branches off into the branch passage portion 25a that is the passage portion located on the high-pressure fuel pump 31-side and into the main passage portion 25b extending from the feed pump 22 to the low-pressure fuel injection mechanism 29. Thus, a required fuel supply amount from the feed pump 22 to the high-pressure fuel pump 31-side can be ensured, and also pulsation propagation from the high-pressure fuel pump 31-side can be suppressed.

Further, in the present embodiment, the orifice 52 is arranged at the position of the pressure node, when the fuel-pressure pulsation becomes strong on the first fuel pipe 25, which is located in the vicinity of the center of the passage length of the first fuel pipe 25. That is, the orifice 52 is arranged in the vicinity of the position of the flow velocity antinode on the low-pressure fuel passage 25c. Thus, a sufficient effect of reducing the fuel-pressure pulsation is provided by the orifice 52. Also, the pulsation damper 51 is arranged in the vicinity of the pressure antinode on the high-pressure fuel pump 31-side when the fuel-pressure pulsation becomes strong on the low-pressure fuel passage 25c, and the orifice 52 is arranged in the vicinity of the pressure node, that is, the flow velocity antinode. Thus, a sufficient effect of reducing the fuel-pressure pulsation is provided.

In addition, in the present embodiment, the pulsation damper 51 reduces fuel-pressure pulsation, caused by an operation of the high-pressure fuel pump 31, within the first pulsation frequency range including the normal speed range of the engine 1. Further, the orifice 52 reduces the fuel-pressure pulsation, having passed through the pulsation damper 51, within at least the second pulsation frequency range that has a higher center frequency and is narrower than the first pulsation frequency range. Therefore, at the idling time at a low idling speed, for example, fuel-pressure pulsation, caused by an operation of the high-pressure fuel pump 31, is effectively damped by the pulsation damper 51. Also, even when the pulsation damping effect of the pulsation damper 51 is reduced at the return time from the fuel-cut stare at a high engine speed, fuel-pressure pulsation at a high pulsation frequency is effectively suppressed by the orifice 52.

In the present embodiment, the injection amount correction section 45b in the ECU 45 corrects the amount of port fuel injection to be performed immediately after pulsation with a fuel-pressure pulsation amplitude detected by the pulsation amplitude detection section 45a according to changes in the amount of the port fuel injection due to the pulsation. Thus, the fuel supply apparatus for an internal combustion engine can be provided, which can approximate the fuel injection amount at the idling time or at the return time from the fuel-cut state to a required injection amount.

As described above, according to the present embodiment, fuel-pressure pulsation, caused by an operation of the high-pressure fuel pump 31, is damped adjacent to the high-pressure fuel pump 31-side by the pulsation damper 51, and the fuel-pressure pulsation having passed through the pulsation damper 51 is reduced by the orifice 52. Therefore, fuel-pressure pulsation, propagated from the high-pressure fuel pump 31 to the low-pressure fuel injection mechanism 29, can be effectively reduced over a wide pulsation frequency range through cooperation of the pulsation damper 51 with the orifice 52. Also, fuel-pressure pulsation on the low-pressure side at the idling time or at the return time from the fuel-cut state can be more effectively suppressed.

In addition to the first embodiment, comparative examples 1, 2, and 3 are prepared as follows. The comparative example 1 is a configuration example in which the orifice 52 is removed from the configuration of the first embodiment, and only the pulsation damper 51 is provided adjacent to the inlet 31i of the high-pressure fuel pump 31. The comparative example 2 is a configuration example in which a pulsation damper element is provided on the low-pressure fuel injection mechanism 29-side relative to the branch point B1, instead of removing the orifice 52 from the configuration of the first embodiment.

The comparative example 3 is an example in which, in contrast to the configuration of the first embodiment, the fuel injection amount correction, based on the fuel-pressure pulsation amplitude detected by the low-pressure fuel-pressure sensor 28 and the pulsation amplitude detection section 45a, is not performed by the injection amount correction section 45b.

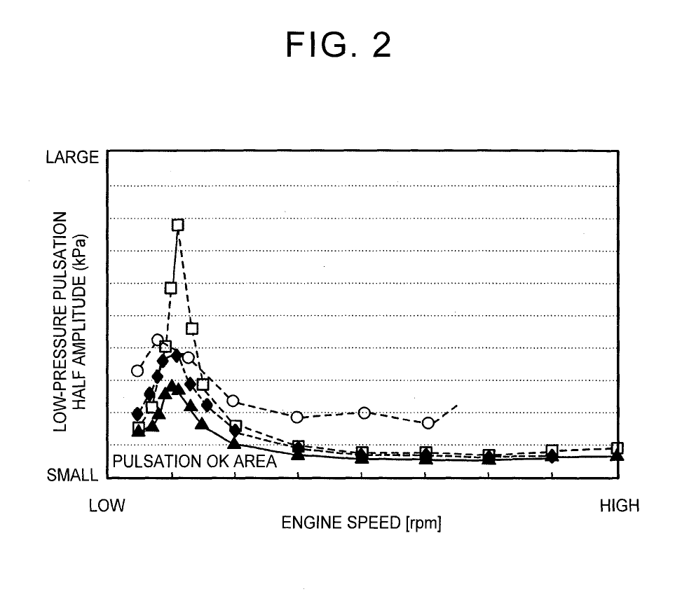

FIG. 2 is a graph showing the half amplitude as results of measurement of fuel-pressure pulsation in a low-pressure-side fuel pipe in the comparative examples 1, 2, and 3, and in the first embodiment.

As shown in FIG. 2, in any of the comparative examples 1, 2, and 3 and the first embodiment, the fuel-pressure pulsation amplitude in the low-pressure-side fuel pipe is large in the idling speed range. In contrast, as shown by the dotted line with open squares in FIG. 2, in the comparative example 1 in which only the pulsation damper 51 is provided adjacent to the inlet 31i of the high-pressure fuel pump 31 without providing the orifice 52, the pulsation amplitude in the idling speed range is significantly larger than in the comparative example 2 and the first embodiment.

As shown by the dotted line with open circles in FIG. 2, in the comparative example 2 in which, instead of removing the orifice 52, the pulsation damper element is provided on the low-pressure fuel injection mechanism 29-side relative to the branch point B1, the pulsation amplitude in the idling speed range is reduced to a greater extent than in the comparative example 1. Meanwhile, in the comparative example 2, there is room for improvement in regard to the fact that the pulsation amplitude on the low-pressure side cannot be sufficiently made small in the normal operating range within which the engine speed exceeds the idling speed range.

As shown by the dotted line with black diamond-shaped marks in FIG. 2, in the comparative example 3 in which the fuel injection amount correction is not performed by the injection amount correction section 45b in contrast to the configuration of the first embodiment, the pulsation amplitude on the low-pressure side can be sufficiently made smaller both in the idling speed range and in the normal operating range that exceeds the idling speed range than in the comparative examples 1 and 2. Also, in the comparative example 3, the pulsation amplitude on the low-pressure side can be sufficiently made small even on the low speed side of the idling speed range.

As shown by the solid line with black triangle marks in FIG. 2, in the first embodiment, the pulsation amplitude on the low-pressure side can be sufficiently made smaller both in the idling speed range and in the normal operating range that exceeds the idling speed range than in the comparative examples 1 and 2. Also, in the first embodiment, the fuel-pressure pulsation amplitude on the low-pressure side is further made smaller both on the low-speed side of the idling speed range and in the normal speed range than in the comparative example 3.

It is apparently understood from the comparison results as described above that in the present embodiment, a sufficient reduction in fuel-pressure pulsation can be expected even on the low speed side of the normal idling speed range. It is also understood that the pulsation on the low-pressure side can be sufficiently suppressed even under the operating conditions in which the engine speed falls within the high speed range of the normal speed range, or in which the engine speed is on the higher side than the high speed range.

Therefore, in the present embodiment, even when the idling speed is reduced, a sufficient pulsation reduction effect can be expected, and the occurrence of variations in air-fuel ratio due to instability of the port injection amount during an idling operation is prevented. In a case where a fuel-cut control is executed at the time of deceleration at a high engine speed, the frequency of fuel-pressure pulsation, caused by the high-pressure fuel pump 31, becomes very high. As described above, even when the frequency of fuel-pressure pulsation becomes too high to be sufficiently absorbed by the pulsation damper 51, the fuel injection amount required for the return time to restart the fuel injection from the fuel-cut state can be sufficiently ensured, and deterioration of vehicle drivability can be prevented.

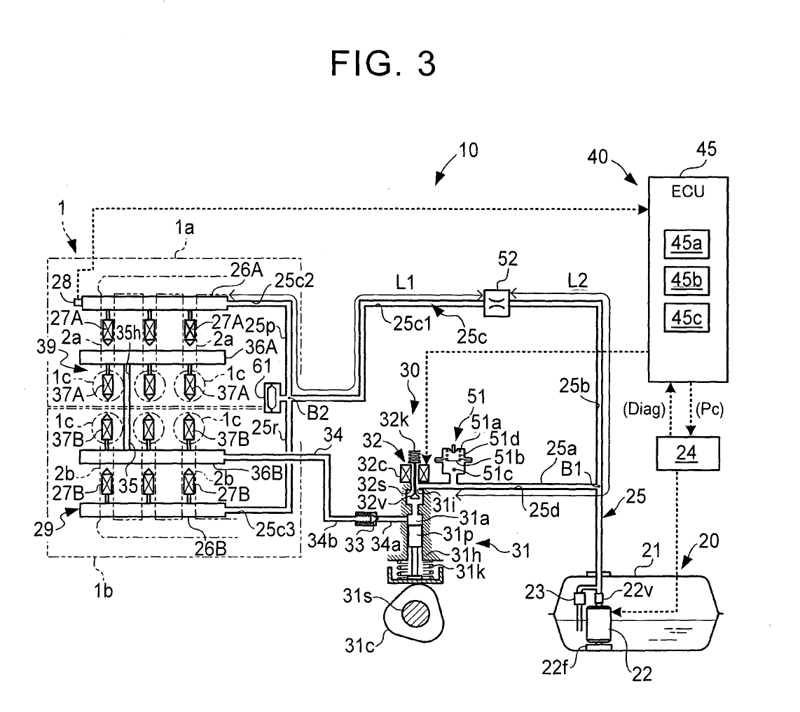

FIG. 3 shows a fuel supply apparatus for an internal combustion engine according to a second embodiment of the present invention.

In the fuel supply apparatus according to the second embodiment, a pulsation damping element is added on the inlet side of the low-pressure fuel injection mechanism 29, in contrast to the fuel supply apparatus 10 according to the first embodiment. Other than that, the fuel supply apparatus according to the second embodiment has the same configuration as the first embodiment. Therefore, in FIG. 3, the constituent elements of the fuel supply apparatus according to the second embodiment, which are the same as those in the first embodiment, are denoted by the same reference numerals as those of the corresponding constituent elements in FIG. 1. Particularly different points are described below.

In a fuel supply apparatus 60 according to the present embodiment, the passage portion 25c1, located on the low-pressure fuel injection mechanism 29-side relative to the orifice 52, in the low-pressure passage 25c between the low-pressure fuel injection mechanism 29 and the second fuel supply mechanism 30, branches off into the branched passage portions 25c2 and 25c3 that correspond to the low-pressure-side delivery pipes 26A and 26B, respectively.

This point is the same as in the fuel supply apparatus 10 according to the first embodiment.

In the present embodiment, a second low-pressure-side pulsation damper 61 (a common pulsation damping element) is provided on a communication passage between the low-pressure-side delivery pipes 26A and 26B, which includes the branched passage portions 25c2 and 25c3. The second low-pressure-side pulsation damper 61 is a pulsation damper that can reduce fuel-pressure pulsation in the low-pressure-side delivery pipes 26A and 26B, which is caused by an operation of the low-pressure fuel injection mechanism 29. The second low-pressure-side pulsation damper 61 is a pulsation damper that is common to the low-pressure-side delivery pipes 26A and 26B.

The pulsation damper 61 is configured by, for example, a case that introduces therein fuel and a hollow damper member formed by joining two metal diaphragms having different rigidity together at their outer peripheral edges. The pulsation damper 61 includes the diaphragms that are accommodated in the case, and that form a pulsation damping chamber around the diaphragms. The diaphragms increase/decrease or change the volume of the pulsation damping chamber according to the fuel pressure that acts on the diaphragms, and accordingly the pulsation damper 61 damps the fuel-pressure pulsation. The two metal diaphragms have different rigidity (bending rigidity), and accordingly while one of the metal diaphragms resonates, the other diaphragm does not resonate, and thus a required pulsation damping effect can be provided. Therefore, the pulsation damper 61 can provide a pulsation reduction effect over a wide pulsation frequency range that includes fuel-pressure pulsation in the low-pressure-side delivery pipes 26A and 26B, which is caused by the port injection, and fuel-pressure pulsation propagated due to an operation of the high-pressure fuel pump 31. The pulsation damper as described above may be configured in the same manner as a publicly-known pressure pulsation reduction mechanism described in Japanese Patent Application Publication No. 2009-174352 (JP 2009-174352 A), for example.

The pulsation damper 61 that is the common pulsation damping element to the low-pressure-side delivery pipes 26A and 26B is located at the branch point B2 on the downstream side at which the passage portion 25c1, located on the low-pressure fuel injection mechanism 29-side relative to the orifice 52, branches off into the branched passage portions 25c2 and 25c3.

Also in the present embodiment, a sufficient pulsation reduction effect can be provided to a reduction in idling speed. Further, even at the return time to restart the fuel injection from the fuel-cut state at a high engine speed, a necessary fuel injection amount can be sufficiently ensured, and deterioration of vehicle drivability can be prevented.

Moreover, even in a case where the low-pressure fuel injection mechanism 29 includes the low-pressure-side delivery pipes 26A and 26B that are arranged in parallel, the pulsation damper 61 common to the low-pressure-side delivery pipes 26A and 26B can damp fuel-pressure pulsation in the low-pressure-side delivery pipes 26A and 26B effectively and inexpensively. The pulsation damper 61 common to the low-pressure-side delivery pipes 26A and 26B can also be utilized for reducing pulsation caused by an operation of the high-pressure fuel pump 31. This can further enhance the pulsation reduction effect on the low-pressure side.

In each of the above embodiments, the present invention is directed to a device applied to the fuel supply apparatuses 10 and 20 for the engine 1 of the V-type. However, the present invention is also applicable to an internal combustion engine that includes a plurality of banks (cylinder banks) other than the engine of the V-type, or to an inline multi-cylinder dual-injection internal combustion engine.

In each of the above embodiments, the plunger 31p of the high-pressure fuel pump 31 reciprocates with the suction control valve 32 opened, thereby propagating pulsation pressure waves, caused by an operation of the high-pressure fuel pump 31, to the low-pressure-side delivery pipes 26A and 26B. The influence of reflective waves of the pulsation pressure waves and the influence of other pressure reducing elements in a pipe path need to be taken into consideration in some cases. An example case is one in which the rate of change in volume of a pipe system is increased by partially using a fuel pipe that is formed from a material with a high rate of change in volume. In such a case, when the influences described above are taken into consideration, it is conceivable that the position of a pressure node, that is the arrangement position of the orifice 52, can be displaced from the center of the low-pressure fuel passage 25c in its lengthwise direction. In that case, the arrangement position of the orifice 52 may be at the position of the pressure node.

As described above, the present invention can effectively reduce fuel-pressure pulsation, propagated from a high-pressure fuel pump to a low-pressure fuel injection mechanism, over a wide pulsation frequency range through cooperation of a pulsation damping element with an orifice. As a result, a fuel supply apparatus for an internal combustion engine can be provided, which can effectively suppress fuel-pressure pulsation on the low-pressure side at the idling time or at the return time from a fuel-cut state. The present invention as described above is useful for any fuel supply apparatus for an internal combustion engine, which can perform direct fuel injection into a cylinder of the internal combustion engine and fuel injection into an intake port thereof.

1. A fuel supply apparatus for an internal combustion engine, the fuel supply apparatus comprising:
a low-pressure fuel injection mechanism;
a high-pressure fuel injection mechanism;
a low-pressure fuel pump that feeds fuel to the internal combustion engine;
a high-pressure fuel pump that pressurizes fuel fed from the low-pressure fuel pump, and that feeds, the pressurized fuel to the high-pressure fuel injection mechanism, the high-pressure fuel pump being mechanically driven by the internal combustion engine;
a first pulsation damping element configured to reduce at least fuel-pressure pulsation caused by an operation of the high-pressure fuel pump, the first pulsation damping element being provided in a passage, located on a high-pressure fuel pump-side, in a fuel pipe interposed between the high-pressure fuel pump and the low-pressure fuel injection mechanism; and
an orifice, that partially reduces a cross-sectional area of a passage, located on a low-pressure fuel injection mechanism-side relative to the first pulsation damping element, in the fuel pipe, the orifice being provided in the passage.

2. The fuel supply apparatus for the internal combustion engine according to claim 1, wherein
the fuel pipe, interposed between the first pulsation damping element and the orifice, branches off into (1) the passage, located on the high-pressure fuel pump-side, and (2) a passage extending from the low-pressure fuel pump to the low-pressure fuel injection mechanism.

3. The fuel supply apparatus for the internal combustion engine according to claim 1, wherein
the orifice is provided at a position on the fuel pipe, which corresponds to a pressure node when the fuel-pressure pulsation becomes strong on the fuel pipe.

4. The fuel supply apparatus for the internal combustion engine according to claim 1, wherein
the orifice is provided at a position of the fuel pipe, which corresponds to a vicinity of a center of a passage length of the fuel pipe from the high-pressure fuel pump to the low-pressure fuel injection mechanism.

5. The fuel supply apparatus for the internal combustion engine according to claim 1, wherein
the first pulsation damping element reduces the fuel-pressure pulsation, caused by the operation of the high-pressure fuel pump, within a first pulsation frequency range,
the orifice reduces the fuel-pressure pulsation, having passed through the first pulsation damping element, within a second pulsation frequency range, and
the second pulsation frequency range is at least a pulsation frequency range that has a higher center frequency and is narrower than the first pulsation frequency range.

6. The fuel supply apparatus for the internal combustion engine according to claim 1, wherein
the low-pressure fuel injection mechanism includes a plurality of low-pressure-side fuel distribution pipes that are arranged in parallel, and
in the fuel pipe, a passage located on the low-pressure fuel injection mechanism-side relative to a position where the orifice is provided branches off into a plurality of passages that correspond to the plurality of low-pressure-side fuel distribution pipes, and
a second pulsation damping element is provided on a communication passage between the plurality of low-pressure-side fuel distribution pipes that includes the plurality of passages, the second pulsation damping element is common to the plurality of low-pressure-side fuel distribution pipes and the second pulsation damping element reduces fuel-pressure pulsation in. the plurality of low-pressure fuel distribution pipes, which is caused by an operation of the low-pressure fuel injection mechanism.

7. The fuel supply apparatus for the internal combustion engine according to claim 6, wherein
the second pulsation damping element is provided at a position where the passage, located on the low-pressure fuel injection mechanism-side relative to the position where the orifice is provided, branches off into the plurality of passages.

8. The fuel supply apparatus for the internal combustion engine according to claim 1, wherein
the first pulsation damping element and the second pulsation damping element are pulsation dampers.
